(19) United States
(12) Patent Application Publication
(10) Pub. No.: US 2018/0162010 A1
(43) Pub. Date: Jun. 14, 2018

(54) DEVICE FOR CONTINUOUS HEATING OF MATERIAL

(71) Applicant: DIEFFENBACHER GMBH MASCHINEN-UND ANLAGENBAU, Eppingen (DE)

(72) Inventor: Helmut BAUSER, Eppingen (DE)

(73) Assignee: DIEFFENBACHER GMBH MASCHINEN-UND ANLAGENBAU, Eppingen (DE)

(21) Appl. No.: 15/573,097

(22) PCT Filed: May 11, 2016
(86) PCT No.: PCT/EP2016/060580

§ 371 Date: Nov. 9, 2017

(30) Foreign Application Priority Data
May 11, 2015 (DE) 10 2015 107 380.3

(51) Int. Cl. B27N 3/18; B27N 3/24; B27N 3/14; B32B 37/10

(52) U.S. Cl. CPC B27N 3/18; B32B 37/1027; B27N 3/14; B27N 3/24

(57) ABSTRACT

The invention relates to a device for continuous heating of materials made of essentially nonmetallic material, comprising a continuous furnace (1) for continuous heating of material (3) on an endless circulating transportation belt (10), wherein the continuous furnace (1) has a plurality of magnetrons (4) for generating electromagnetic waves and waveguides (5) having outlet openings (6) for feeding the waves into a radiation chamber (14), and wherein the outlet openings (6) of the waveguides (5) have a main axis. The invention is distinguished in that, in the case of at least two outlet openings (6), which are arranged as closest neighbors in and/or transversely in relation to the production direction (15), the main axes (23) of the outlet openings (6) enclose an angle greater than 0° and/or the connecting line (25) of the focal points (24) of the areas of the outlet openings (6) enclose an angle greater than 0° on the perpendicular in relation to the production direction (15).

The invention relates to a device for continuous heating of materials made of essentially nonmetallic material, according to the preamble of Patent Claim 1.

The continuous heating of material, in particular made of substantially nonmetallic material, has a decisive role in many fields of the production of products and intermediate products.

In particular in the compression of pulverized and/or digested biomass, wood, or woodlike materials to form material slabs, the continuous heating of materials is of decisive significance. Examples of such material slabs are MDF slabs made of moderate density fibers, oriented strand boards (OSB), veneer boards (LVL, OSL), fibrous insulation slabs/mats, or the like. To increase the production performance of continuously operating presses, furthermore heating material which is scattered to form a nonwoven material or strand using suitable devices before the entry into the press is known. Due to the higher level of heat at the beginning of the compression, the press requires less time to heat through the nonwoven material. The press can accordingly be designed shorter or operated more rapidly. Hot air or steam pre-heaters or the use of high-frequency radiation (HF, MW) for preheating in microwave continuous furnaces, referred to as continuous furnaces hereafter, has proven itself. The physical principle is based on the conversion of electromechanical energy into thermal energy upon the absorption of the microwaves by the material to be heated.

A method and a device for heating a nonwoven material before a press is known from EP 2 247 418 B1. In this disclosure, it is proposed that, in a continuous furnace, 20 to 300 microwave generators having magnetrons of a power of 3 to 50 kW and having a frequency range of 2400-2500 MHz are to be arranged per press flat side. The large number of generators and the frequency used, which are necessary for the device and the method, advantageously result in a small size of the radiation openings in the heating chamber at the microwave frequency used. The disclosure only teaches a person skilled in the art that a plurality of microwave generators having equal power are used and are also accordingly to be controlled uniformly.

The device and the method described in this patent have proven themselves in industrial use, but may be further improved for industrial application.

Furthermore, evening out the microwaves inside a heating chamber, referred to hereafter as a radiation chamber, by means of suitable devices is generally known. Such devices are, for example, metallic rotors. Alternatively, the material to be heated can be placed on rotating turntables. In a continuous furnace to which multiple microwave generators, referred to as magnetrons hereafter, are applied, such a homogenization of the radiation inside the radiation chamber can also be advisable, even if the material to be heated is already guided continuously through the radiation chamber by means of a transportation belt.

Details with respect to safety-relevant embodiments or other embodiments of the airlock technology of the continuous furnace for introducing and discharging the material is described in refining prior art and is not the subject matter of the present invention.

A plurality of magnetrons is used in the above-mentioned prior art to generate the required heating of the material. The expenditure appears justified since the material can be heated through without introducing moisture into the material, as would be the case, for example, upon the use of steam. The higher energy introduction and the costs connected thereto pay off due to the lower specific energy consumption per unit of the end product.

The above-mentioned prior art has the disadvantage that in spite of the above-mentioned possibilities for evening out the radiation in the radiation chamber, for example, wobblers, moving material, the result of the heating is excessively irregular. Occurring hot spots or regions which are not heated enough ensure problems during the curing of the material in the press. In particular in the production of material slabs, such inhomogeneities in the temperature profile result in reduced lateral tensile strengths of the material slabs and therefore in discards or lower-quality material.

The object of the present invention is to refine the device and the method so that the uniform heating of the material is ensured.

The invention proceeds in this case from a device for continuously heating materials made of substantially nonmetallic material, comprising a continuous furnace for the continuous heating of material on an endless circulating transportation belt, wherein the continuous furnace has a plurality of magnetrons for generating electromagnetic waves and waveguides having outlet openings for feeding the waves into a radiation chamber, and wherein the outlet openings of the waveguides have a main axis.

The stated object is achieved for the device according to the invention in that in the case of at least two outlet openings, which are arranged as closest neighbors in and/or transversely in relation to the production direction, the main axes of the outlet openings enclose an angle greater than 0° and/or the connecting line of the focal points of the areas of the outlet openings enclose an angle greater than 0° to the perpendicular in relation to the production direction.

The main axis is understood hereafter as the longest axis of the outlet openings of the waveguides if not defined otherwise. In the case of rectangular outlet openings, the main axis is to be understood as the longer center perpendicular, in the case of square outlet openings, the center perpendicular, in the case of oval outlet openings, the longest diameter, and in the case of round outlet openings, the diameter. For the arrangement as the closest neighbor, solely the distance of the focal points of the areas of the outlet openings in and transversely in relation to the production direction are considered for this purpose. The closest neighbor transversely in relation to the production direction results from the least distance of the focal points transversely in relation to the production direction, the closest neighbor in the production direction results from the least distance in the production direction.

The invention has recognized that the arrangement of the outlet openings of the waveguides in the radiation chamber has particular significance. The present invention therefore has the advantage that by way of targeted pivoting of the main axes of the outlet openings, and/or pivoting of the connecting line of the focal points of the areas of the outlet openings in relation to the perpendiculars on the production direction of at least two outlet openings, which are arranged as closest neighbors in and/or transversely in relation to the production direction, the heat introduction into the material can be influenced to a particular extent and in particular results in homogenization of the heat introduction. The temperature distribution in the material therefore becomes more homogeneous, which finally has an effect on the properties of the material. Hot spots, therefore regions in which an increased introduction of energy takes place during the transport of the material in the continuous furnace, can advantageously be suppressed. The material is heated through uniformly, which also has an advantageous effect for processes subsequent thereto. The number of the outlet openings or the magnetrons, respectively, is finally dependent on the material to be heated. The arrangement of the outlet openings according to the present invention also enables, however, a targeted introduction of heat which is tailored to the material. By way of such an offset arrangement of the outlet openings according to the present invention, the vectors of the microwave radiation now enter the material at different angles, which can result in excitations of different strengths in the material itself. Furthermore, it is also advantageous that regions which were heretofore not acquired by microwave radiation or which were only heated indirectly by means of microwave radiation may now also have microwave radiation applied thereto by the targeted arrangement of the outlet openings, which are arranged as closest neighbors.

The material is preferably provided as an endless strand on the transportation belt and has two flat sides, wherein one of these flat sides rests on the transportation belt and has at least two edges in the production direction.

In a preferred manner, the angle between the main axes of the outlet openings is selected as less than or equal to 180°, preferably less than or equal to 90°.

Alternatively or in combination, the angle between the connecting line of the focal points of the areas of the outlet openings on the perpendicular in relation to the production direction is selected as less than 90°. The measurement of the angle of the connecting line of the focal points of the areas of the outlet openings can be performed from the perpendicular on the production direction in relation to the connecting line and also from the connecting line in relation to the perpendicular on the production direction.

The main axes of the outlet openings are particularly preferably perpendicular to one another. This “pattern” of the outlet openings, which are arranged as closest neighbors, can be arranged only in a locally limited manner, on the one hand, but also in the entire continuous furnace.

In one preferred embodiment, a press is connected downstream of the continuous furnace in the production direction. The transport route between the continuous furnace and the press is to be selected as short as possible, whereby the material only suffers minimal heat loss.

Alternatively or in combination, the device can be capable of the continuous production of materials, preferably for the production of material slabs. Material slabs are understood in particular as wooden material slabs such as chipboard, fiberboard, or OSB slabs, but also plastic slabs or other slabs which can be produced by means of a press, in particular by means of a continuous press. In particular in the production of material slabs in a continuous press, a starting material heated homogeneously by the device for heating enables more rapid compression of the material due to an increased speed of the transportation belt or the press can be embodied as shorter per se.

Alternatively or additionally, a control or regulating device is arranged for controlling individual or grouped magnetrons, to operate them using different powers to prepare a differentiated power profile, preferably in and/or transversely in relation to the production direction. The microwave introduction can therefore be controlled or regulated not only via the arrangement of the outlet openings, but rather also via the power.

The outlet openings of the waveguides are advantageously arranged in one or more planes parallel or at an angle in relation to the plane of the transportation belt.

Preferably, round, square, rectangular, and/or oval waveguides are arranged having corresponding outlet openings. Only waveguides of one cross section and/or one type of outlet openings can be arranged, or also various waveguides can be arranged mixed.

Alternatively or additionally, the outlet openings are arranged in rows and columns longitudinally and transversely in relation to the production direction. Therefore, a global and/or regular arrangement of the outlet openings can exist, which is interrupted locally by the arrangement of the outlet openings at an angle of the half-axes thereof or the connecting line of the focal points perpendicularly to the production direction.

In a further embodiment, the control or regulating device is capable of retrieving predefined power profiles proceeding from the material and/or the product to be produced and setting them in the continuous furnace.

The magnetrons preferably have different powers. It can be advantageous depending on the material, in particular from an energetic aspect, to already equip individual magnetrons with lower power beforehand.

Magnetrons having a power of 0.5 to 20 kW, preferably up to 6 kW, are preferably arranged.

Alternatively or in combination, a passive and/or active distribution material for the electromagnetic waves is arranged in the radiation chamber. In this way, a further homogenization of the distribution of the waves can be achieved, which finally has an advantageous effect on the heat introduction into the material.

In a further embodiment, outlet openings are arranged so they are rotatable manually or by means of the control and regulating device. This enables a targeted control of the outlet openings and therefore of the introduction of energy into the material. The possibility is thus opened up of the material changing during the process and the device being able to be changed in a manner adapted to the new material accordingly without refitting times.

Details and exemplary embodiments of the invention will be explained in greater detail on the basis of the appended drawings.

### IN THE DRAWINGS:

FIG. 1 shows a schematic side view (top) and an associated schematic top view (bottom) of a device having a strand made of material, which is guided in the production direction through a continuous furnace and a double belt press,

FIG. 2 shows a top view of the cover of the radiation chamber of the continuous furnace having an exemplary arrangement of the waveguides,

FIG. 3 shows a section X3 in the production direction according to FIG. 2 through the radiation chamber and

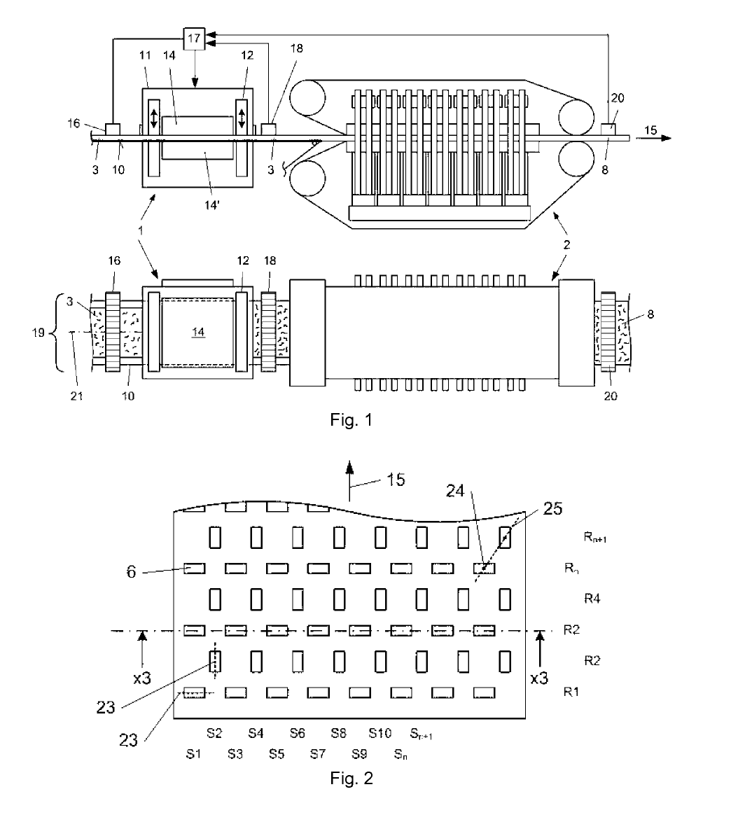

FIG. 1 shows a schematic side view at the top and an associated schematic top view at the bottom of a device having two endlessly revolving steel belts, which pull the strand-shaped material 3 through the press 2, in the production direction 15 through a continuous furnace 1 and a continuously operating press 2. The material 3 is transported in this case on a transportation belt 10 from the left through the continuous furnace 1, heated therein in a radiation chamber 14, transferred to the press 2 and compressed and cured therein to form a product 8.

Depending on the embodiment of the device, for a higher efficiency, a radiation chamber 14 can be arranged not only from one upper or lower flat side, but rather a radiation chamber 14′ can also apply microwaves to the material 3 from the other flat side. This can be necessary in particular if, because of a lack of penetration depth of the microwaves from one side, the material 3 cannot be heated through sufficiently or if the power for heating is to be increased. The continuous furnace 1 also has, around the radiation chamber 14, in addition to a shielding housing 11, absorbers 12, which absorb excess microwaves on the inlet and outlet sides and in addition to the airlocks, which are only indicated therein, prevent the exit of microwaves from the continuous furnace 1. The airlocks and/or the absorbers 12 are embodied as adjustable in height and/or width for adaptation to various heights and widths of the material 3 passing through.

The device can have a control or regulating device 17, which is capable of controlling the power of the plurality of magnetrons 4 for producing microwaves. In particular, the control or regulating device 17 can control magnetrons 4 individually or in groups. The control or regulating device 17 is preferably operationally connected to a memory device and/or a computer unit, which already contains formulas or predefined frame data for setting the continuous furnace 1 or the magnetrons 4, respectively. In particular, computation principles can be stored here, on the basis of which the control or regulating device 17, in conjunction with inputs of the operator with respect to the type of the material 3 and/or the product 8 to be produced, implements proposals or settings, using which the continuous furnace 1, in conjunction with the downstream press 2, can operate in a range which is optimum and harmless to the material 3.

In an alternative or combined embodiment, in the production direction 15, measuring devices 16 can be arranged before the continuous furnace 1, and measuring devices 18 can be arranged after the continuous furnace 1 and before the press 2 for the material 3. Alternatively or in combination, a measuring device 20 for the product 8 can be arranged at the outlet of the press 2. All of these mentioned or possibly further measuring devices share the feature that they are operationally connected to the control or regulating device 17 and can transmit their measurement results thereto. These measurements are the foundation for control or regulating algorithms and cause the generation and transmission in the control or regulating device 17 of corresponding commands to the continuous furnace 1 or the magnetrons 4 arranged therein, respectively.

Alternatively or in combination, further prior devices of the production facility or the control center of the facility, respectively, can be operationally connected to the control or regulating device 17 to transmit data.

These measuring devices 16, 18, 20 can preferably be capable of performing measurements over sections of the width 19 of the material 3 or the product 8, respectively.

As can furthermore be inferred from FIG. 1, the material 3 is applied to the transportation belt 10 in a height which is small in relation to the width 19. The material 3 is preferably compressed in this width 19 in the following press 2 to form the product 8. The material 3 is therefore preferably strand-shaped, has an upper and a lower flat side in this case, wherein one flat side rests on the transportation belt 10 and forms two edges 7.

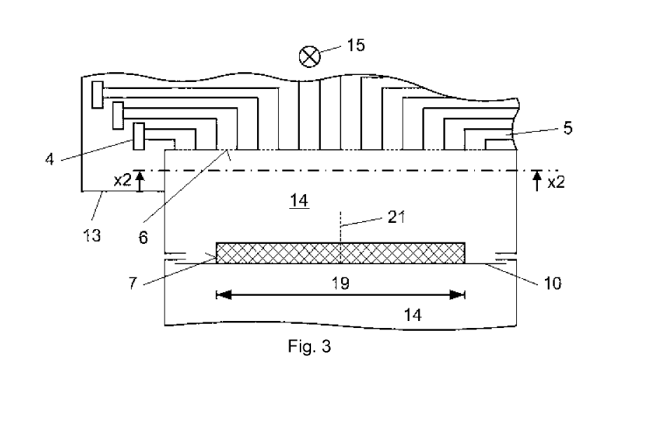

FIG. 2 shows a top view in the production direction 15 from bottom to top of the cover 22 of the radiation chamber 14 in a section X2-X2 from FIG. 3. FIG. 3 shows the corresponding view of a section X3-X3 through the radiation chamber 14 according to FIG. 2, wherein the production direction 15 is oriented in the plane of the drawing.

In the combined consideration of the two FIGS. 2 and 3, the following embodiment of the radiation chamber 14 results. The magnetrons 4 are preferably arranged separately in a cabinet 13 and for better accessibility, in particular for maintenance or replacement purposes, laterally to the radiation chamber 14. The cabinet 13 has passages, through which the waveguides 5 connected to the magnetrons 4 conduct the microwaves to the radiation chamber 14 and introduce them via the outlet openings 6, corresponding to openings in the cover 22, into the radiation chamber 14. It is recognizable in the top view that the outlet openings 6 are arranged in multiple rows R (Rₙ, Rₙ₊₁) transversely in relation to the production direction 15 and columns S (Sₙ, Sₙ₊₁) longitudinally in relation to the production direction 15.

The manner of the arrangement of the outlet openings 6 on the radiation chamber 14 is dependent on the use of the continuous furnace 1, the frequency of the microwave radiation, which has an influence on the size of the waveguides 5 and therefore on the outlet openings 6, and in particular also on the type and the volume of the material 3 to be heated. It can therefore be possible to use only a small number of magnetrons 4, wherein at least two have to be arranged. These then form a row in an arbitrary direction. However, it is preferably provided that at least multiple magnetrons 4 are arranged in a row R and can be controlled by means of the control or regulating device 17 using a differentiated power profile 9. One row R, possibly not necessarily transverse but at an angle (not parallel) to the production direction, already enables the differentiated heating of the material 3 over the width 19.

Furthermore, the main axes 23 of two outlet openings 6 are shown by way of example in the left lower corner in FIG. 2. In this exemplary embodiment, the main axes 23 of the rectangular outlet openings 6 form an angle of 90° in relation to one another. Viewed from the left lower outlet opening 6, the outlet opening 6 arranged adjacent thereto in the same series R1 forms the closest neighbor transversely in relation to the production direction 15, the outlet opening 6 arranged in the row S2, in which the main axis 23 is shown, forms the closest neighbor in the production direction 15.

Two adjacent openings 6 are also shown indicated by way of example in the right upper corner in FIG. 2, the focal points 24 of which (shown by dots) of the areas of the outlet openings 6 are connected by the connecting line 25. This connecting line 25 encloses an angle in relation to the perpendicular on the production direction 15.

According to FIG. 3, a second radiation chamber 14′ can be provided, which is arranged opposite to the first radiation chamber 14 with respect to the material 3 and therefore below the transportation belt 10. It can preferably have the same configuration of magnetrons/waveguides/outlet openings as the radiation chamber 14. The material 3 to be heated here has a predefined width 19 and rests on the transportation belt 10 traveling through the continuous furnace 1. The material 3 is formed essentially strand-shaped, has two flat sides, and one edge 7 on each side.

### LIST OF REFERENCE SIGNS

1 continuous furnace
2 press
3 material
4 magnetron
5 waveguide
6 outlet opening
7 edge
8 product
9 power profile
10 transportation belt
11 housing
12 absorber
13 cabinet
14 radiation chamber
15 production direction
16 measuring device
17 control or regulating device
18 measuring device
19 width
20 measuring device
21 longitudinal center line
22 cover
23 main axis
24 focal point
25 connecting line
R row of the outlet openings transversely in relation to 15
S column of the outlet openings in 15
L power of 4

1. A device for continuous heating of materials made of essentially nonmetallic material, comprising
a continuous furnace configured for continuous heating of material on an endless circulating transportation belt, the continuous furnace comprising a plurality of magnetrons configured for generating electromagnetic waves and waveguides having outlet openings configured for feeding the waves into a radiation chamber,
wherein the outlet openings of the waveguides have a main axis, and
wherein in a case of at least two outlet openings, which are arranged as closest neighbors in and/or transversely in relation to a production direction, main axes of the outlet openings enclose an angle greater than 0° and/or a connecting line of focal points of areas of the outlet openings enclose an angle greater than 0° on a perpendicular in relation to the production direction.

2. The device according to claim 1, wherein the angle between the main axes of the outlet openings is less than or equal to 180°.

3. The device according to claim 1, wherein the angle between the connecting line of the focal points of the areas of the outlet openings on the perpendicular in relation to the production direction is less than 90°.

4. The device according to claim 1, wherein the main axes of the outlet openings are perpendicular to one another.

5. The device according to claim 1, further comprising a press connected downstream in the production direction.

6. The device according to claim 1, wherein the device is configured for continuous production of materials.

7. The device according to claim 1, further comprising a control or regulating device configured for controlling individual or grouped magnetrons, to operate them using different powers to prepare a differentiated power profile, in and/or transversely in relation to the production direction.

8. The device according to claim 1, wherein the outlet openings of the waveguides are arranged in one or more planes parallel or at an angle in relation to a plane of the transportation belt.

9. The device according to claim 1, wherein the waveguides comprise round, square, rectangular, and/or oval waveguides.

10. The device according to claim 1, wherein the outlet openings are arranged in rows and columns longitudinally and transversely in relation to the production direction.

11. The device according to claim 1, further comprising a control or regulating device configured to, proceeding from the material and/or a product to be produced, retrieve predefined power profiles and set them in the continuous furnace.

12. The device according to claim 1, wherein the magnetrons have different powers.

13. The device according to claim 1, wherein the magnetrons have a power of 0.5 to 20 kW.

14. The device according to claim 1, wherein a passive and/or active distribution means for the electromagnetic waves is arranged in the radiation chamber.

15. The device according to claim 1, wherein the outlet openings are configured to be rotated manually or via a control or regulating device.

16. The device according to claim 1, wherein the angle between the main axes of the outlet openings is less than or equal to 90°.

17. The device according to claim 1, wherein the device is configured for continuous production of material slabs.

18. The device according to claim 13, wherein the magnetrons have a power up to 6 kW.
